(19) United States
(12) Patent Application Publication
(10) Pub. No.: US 2007/0103285 A1
(43) Pub. Date: May 10, 2007

(54) Antenna apparatus disposed in tire

(75) Inventors: Yasuhiro Konno, Fukushima-ken (JP); Makoto Shigihara, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/521,755

(22) Filed: Sep. 15, 2006

(30) Foreign Application Priority Data
Nov. 4, 2005 (JP) 2005-320970

(51) Int. Cl. B60C 23/00; B60C 19/08; G08B 13/14

(52) U.S. Cl. 340/447; 152/152.1; 340/572.7

(57) ABSTRACT

An antenna apparatus including an inverse-F antenna is disposed on an inner surface of a tread, in which steel wires are embedded, of a tire, so that the antenna apparatus is disposed at an outer periphery of a ring space in the tire. The antenna apparatus includes: a metal base plate as a supporting member which also serves as a grounding conductor; a circuit board on which a high-frequency circuit including a transmitting/receiving circuit and the like is disposed, and is mounted on the metal base plate; an antenna element which is electrically connected to the high-frequency circuit and radiates a vertical polarization; and a case made of synthetic resin for covering the circuit board and the antenna element, in which the circuit board and the antenna element are located at the inner side of the metal base plate in a radial direction of the tire.

### BACKGROUND OF THE INVENTION

1. Field of the Invention

The present invention relates to an antenna apparatus which is disposed in a tire of a vehicle and used as a transponder applied to a system for monitoring an air pressure of a tire or the like.

2. Description of the Related Art

In recent years, attention has been devoted to a system for monitoring an air pressure of a tire by disposing an antenna apparatus, in which a pressure sensor is embedded, in a tire, so that a driver can obtain the air pressure of the tire even in traveling of the vehicle. In such tire-pressure monitoring system (TPMS), the antenna apparatus in the tire is used as a transponder. In particular, when the antenna apparatus receives an interrogation signal from an interrogator provided in a vehicle body, the antenna apparatus transmits information on the air pressure of the tire, which is detected by the pressure sensor, such as a quartz vibrator, to the interrogator.

This antenna apparatus has an antenna element, a circuit board, and the like. On the circuit board, a high-frequency circuit including a detection circuit having the pressure sensor, a transmitting/receiving circuit, and the like, is disposed. Conventionally, there has been known a configuration in which such an antenna apparatus is disposed at an innermost periphery of a space in a tire by attaching the antenna apparatus at an air valve or on a wheel (for example, see Japanese Unexamined Patent Application Publication No. 2002-219915, pages 2 to 3, and FIG. 4). In particular, an antenna apparatus including a patch antenna and the like is attached at the air valve to be disposed in the vicinity of a rim of the wheel, or an antenna apparatus including a loop antenna and the like is fixed on an outer periphery of the wheel by using a metal band. Alternatively, a configuration in which an antenna apparatus used for a transponder is embedded in a tire at the vicinity of a bead has been suggested (for example, see Japanese Unexamined Patent Application Publication No. 5-169931, pages 6 to 11, and FIG. 1).

According to the configuration in which the antenna apparatus is disposed at the innermost periphery of the space in the tire by using the air valve or the wheel, a tool or the like for detaching the tire from the rim of the wheel may abut on the antenna apparatus, and may damage the antenna apparatus. To avoid the damage, the tire has to be detached carefully, thereby decreasing workability. In addition, when a frequency band of transmitting/receiving waves is set to as high as several GHz, the rim of the wheel may obstructs the wave, thereby decreasing an antenna sensitivity.

According to the related art configuration in which the antenna apparatus is embedded in the tire at the vicinity of the bead, tire-manufacturing procedures may be troublesome, and the total manufacturing cost may markedly increase. In addition, the antenna apparatus may not be attached later, which is not convenient.

### SUMMARY OF THE INVENTION

To solve the above-described problems of the related arts, it is an object of the present invention to provide an antenna apparatus which is disposed in a space of a tire, has a good antenna sensitivity, and would not be damaged when the tire is detached.

To attain the above-mentioned object, an antenna apparatus according to an aspect of the present invention includes: a circuit board on which a high-frequency circuit including a transmitting/receiving circuit is disposed; and an antenna element which is electrically connected to the high-frequency circuit and radiates a vertical polarization, in which the antenna apparatus is disposed on an inner surface of a tread, in which steel wires are embedded, of a tire.

When the tire is detached from a rim of a wheel, sidewalls of the tire must be elastically deformed. However, the tread with the steel wires embedded would not be deformed in the detachement work. Therefore, since the antenna apparatus is disposed on the inner surface of the tread, the anenna apparatus may be disposed in a secure location where the antenna apparatus would not be damaged when the tire is detached, and accordingly, the tire may be easily detached. In addition, since the steel wires embedded in the tread may be utilized as a grounding conductor for the antenna element, the antenna apparatus capable of increasing a gain thereof, and of effectively radiating a vertical polarization in a direction of the sidewalls of the tire, can be provided. Therefore, a good antenna sensitivity may be expected even when a frequency band of transmitting/receiving waves is as high as several GHz. Further, since the antenna apparatus is used by being attached on the inner surface of the tire, the usability of the antenna apparatus is good and the manufacturing cost is low, as compared to an antenna apparatus which is used by being embedded in a tire.

Preferably in the above-described configuration, the antenna apparatus may further include: a metal base plate for holding the circuit board and the antenna element, and the metal base plate may be fixed on the inner surface of the tread of the tire, so that the circuit board and the antenna element are located at the inner side of the metal base plate in a radial direction of the tire. Accordingly, the metal base plate may be used as a supporting member which also serves as a grounding conductor, and centrifugal force exerted by high-speed rotation of the tire would not act as a force for separating the circuit board and the antenna element from the metal base plate, thereby hardly causing a damage trouble on the antenna apparatus due to the centrifugal force.

Preferably in the above-described configuration, the antenna apparatus may be disposed on the inner surface at the center in a width direction of the tread of the tire. Accordingly, the antenna apparatus may be mechanically stable because unwanted external force hardly acts on the antenna apparatus, and antenna property may be also stable because the position of the antenna apparatus would not be deviated with respect to the steel wires embedded in the tread.

Preferably in the above-described configuration, the antenna element may be an inverse-F antenna for radiating a vertical polarization. Accordingly, a small antenna element can be easily manufactured at low cost by processing a metal plate. Alternatively, the antenna element may be a compound antenna which includes a helical antenna and a monopole antenna, the helical antenna extending helically and having an end connected to the metal base plate and another end being open, the monopole antenna being vertically mounted at a location to be substantially aligned with the center line of the helical antenna and having an end connected to the high-frequency circuit and another end being open, the helical antenna and the monopole antenna being electromagnetically connected to each other. Accordingly, impedance matching can be easily performed, and the compound antenna may be resonated according to different frequency bands.

Preferably in the above-described configuration, the antenna apparatus may further include a case made of synthetic resin for covering the circuit board and the antenna element. Accprdingly, waterproof property and dust resistance may increase for the circuit board and the antenna element, and reliability of the antenna apparatus may be secured.

### BRIEF DESCRIPTION OF THE DRAWINGS

FIG. 1 is an explanatory view showing a state where an antenna apparatus is disposed in a tire according to a first embodiment of the present invention;

FIG. 2 is an explanatory view showing the antenna apparatus; and

FIG. 3 is an explanatory view showing an antenna apparatus according to a second embodiment of the present invention.

### DESCRIPTION OF THE PREFERRED EMBODIMENTS

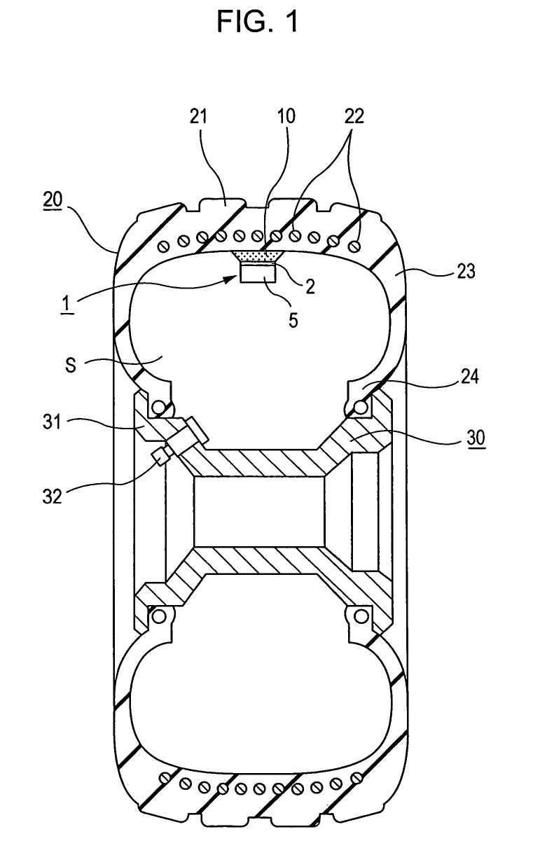

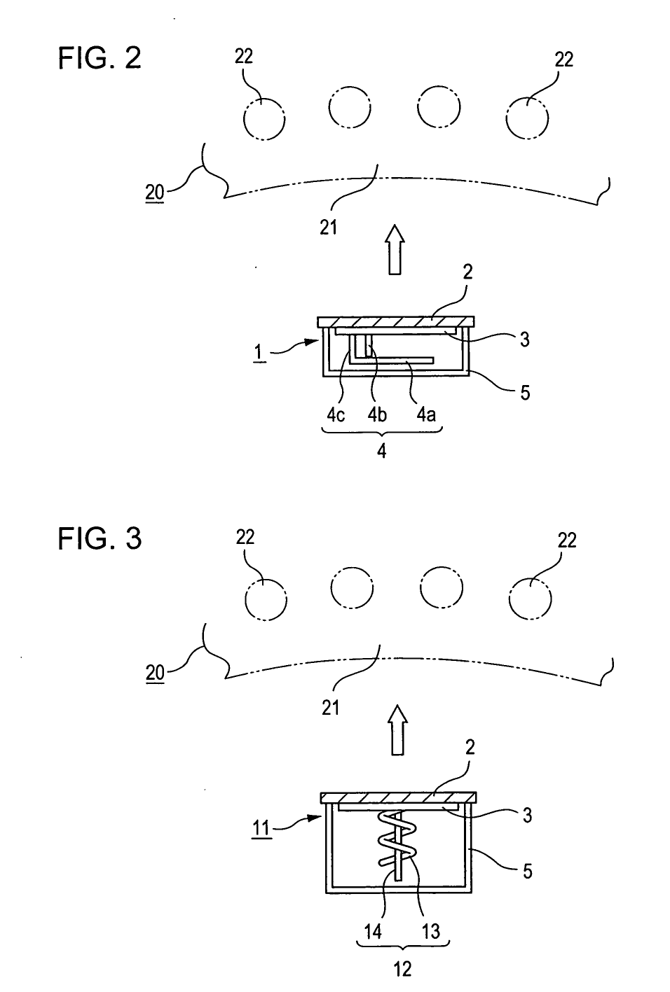

Embodiments of the present invention will be described with reference to the drawings. FIG. 1 is an explanatory view showing a state where an antenna apparatus is disposed in a tire according to a first embodiment of the present invention, and FIG. 2 is an explanatory view showing the antenna apparatus.

An antenna apparatus 1 shown in each of the drawings is disposed in a tire 20 and used as a transponder for a tire-pressure monitoring system (TPMS). Steel wires 22 are embedded in a tread 21 of the tire 20. The antenna apparatus 1 is mainly composed of a metal base plate 2, a circuit board 3 mounted on a surface of the metal base plate 2, an antenna element 4 which is formed as an inverse-F antenna and is vertically mounted on the circuit board 3, and a case 5 which covers the circuit board 3 and the antenna element 4, and fixed at the metal base plate 2. The metal base plate 2 is fixed on an inner surface at the center in a width direction (left-right direction shown in FIG. 1) of the tread 21 of the tire 20, with an attachment member 10 made of rubber or the like, or an adhesive (not shown) interposed therebetween, so that the antenna apparatus 1 is disposed on an outer periphery of a ring space S in the tire 20. As shown in FIG. 1, beads 24 provided at inner peripheral sides of sidewalls 23 are fitted into a rim 31, so that the tire 20 is mounted on a wheel 30. An air valve 32 is attached to the wheel 30.

To be more specific about the configuration of the antenna apparatus 1, the metal base plate 2 is a rectangular metal plate, and the circuit board 3 is mounted and fixed on a surface of the metal base plate 2 opposite to a surface thereof facing the tread 21. On the circuit board 3, a high-frequency circuit including a detection circuit having a pressure sensor, a transmitting/receiving circuit, and the like, is disposed on a surface of the circuit board 3 opposite to a surface thereof facing the metal base plate 2. An earthed circuit of the circuit board 3 is electrically connected to the metal base plate 2. The antenna element 4 is an inverse-F antenna, which is formed by punching a metal plate into a predetermined shape, and bending the punched metal plate. The antenna element 4 includes a radial conductor 4a disposed substantially in parallel to the metal base plate 2, a feed pin 4b so formed that a bent piece extending from a feed point of the radial conductor 4a toward the circuit board 3 is soldered to the high-frequency circuit, and a short-circuit pin 4c so formed that a bent piece extending from an end of the radial conductor 4a toward the circuit board 3 is soldered to the earthed circuit. Since electric fields are generated between the radial conductor 4a and the metal base plate 2 or the steel wires 22 during feeding, the antenna element 4 may function as a vertical polarization antenna. The case 5 is a synthetic resin casing, and covers the circuit board 3 and the antenna element 4 to increase waterproof property and dust resistance and secure reliability of the antenna apparatus.

The antenna apparatus 1 according to the present embodiment is disposed at the outer periphery of the ring space S in the tire 20 by fixing the metal base plate 2 on the inner surface of the tread 21 having the steel wires 22 embedded. Therefore, when the tire 20 is detached from the rim 31 of the wheel 30, a tool or the like would not abut on the antenna apparatus 1, and the tread 21 would not be deformed according to the detachment work of the tire 20. That is, the antenna apparatus 1 is disposed in a secure location where the antenna apparatus 1 would not be damaged when the tire 20 is detached, and accordingly, the workability increases and the tire 20 may be easily detached. In addition, since the antenna apparatus 1 may utilize the steel wires 22 embedded in the tread 21 as a grounding conductor for the antenna element (inverse-F antenna) 4, a gain of the antenna apparatus 1 may easily increase. Therefore, the vertical polarization may be radiated effectively in a direction of the sidewalls 23 of the tire 20. Even when a frequency band of transmitting/receiving waves is as high as several GHz (for example, 2.4 GHz), a good antenna sensitivity may be expected.

Since the antenna apparatus 1 uses the metal base plate 2 as a supporting member which also serves as the grounding conductor, and uses the antenna element 4 having the inverse-F antenna structure, the apparatus can be reduced in size, and mechanical strength thereof can be easily secured. In addition, in the antenna apparatus 1, since the circuit board 3 and the antenna element 4 are disposed at the inner side of the metal base plate 2 in a radial direction of the tire 20, centrifugal force exerted by high-speed rotation of the tire 20 would not act as a force for separating the circuit board 3 and the antenna element 4 from the metal base plate 2, thereby hardly causing a damage trouble on the antenna apparatus 1 due to the centrifugal force. Further, since the antenna apparatus 1 is used by being attached on the inner surface of the tire 20, the usability of the antenna apparatus 1 is good and the manufacturing cost is low, as compared to an antenna apparatus which is used by being embedded in a tire.

The similar effects may be expected even if the location of the antenna apparatus 1 is slightly deviated from the center in the width direction of the tread 21. However, as the antenna apparatus 1 is disposed on the inner surface at the center in the width direction of the tread 21 similarly to the present embodiment, the antenna apparatus 1 may be mechanically stable because unwanted external force hardly acts on the antenna apparatus 1, and antenna property may be also stable because the position of the antenna apparatus 1 would not be deviated with respect to the steel wires 22 embedded in the tread 21.

FIG. 3 is an explanatory illustration showing an antenna apparatus according to a second embodiment of the present invention. The same reference numerals are given to the parts corresponding to FIG. 2, and the description on such parts will be omitted.

An antenna apparatus 11 according to the second embodiment is disposed in the tire 20 by being disposed on the inner surface of the tread 21 similarly to the antenna apparatus 1 according to the first embodiment. However, the structure of an antenna element is different from the inverse-F antenna according to the first embodiment.

In particular, an antenna element 12 of the antenna apparatus 11 shown in FIG. 3 is a compound antenna in which a helical antenna 13 as a passive element is combined with a monopole antenna 14 as a feed element. The helical antenna 13 and the monopole antenna 14 are electromagnetically connected to each other. The helical antenna 13 is made from a helically extending metal wire rod, and an end thereof is connected to the metal base plate 2 while another end thereof is open. The monopole antenna 14 is made from a linearly extending metal rod, vertically mounted at a location to be substantially aligned with the center line of the helical antenna 13, and an end of the monopole antenna 14 is connected to the high-frequency circuit of the circuit board 3 while another end thereof is open.

In the antenna element 12 of the antenna apparatus 11 having the above-described configuration, since the monopole antenna 14 as the feed element is vertically mounted at the location to be substantially aligned with the center line of the helical antenna 13 as the passive element, impedance matching can be easily performed by adjusting the length of the monopole antenna 14. In addition, in the antenna apparatus 11, since the helical antenna 13 and the monopole antenna 14 can be resonated according to different frequency bands, the helical antenna 13 and the monopole antenna 14 can easily correspond to a receiving frequency and a transmitting frequency.

What is claimed is:

1. An antenna apparatus comprising:
a circuit board in which a high-frequency circuit including a transmitting/receiving circuit is disposed; and
an antenna element which is electrically connected to the high-frequency circuit and radiates a vertical polarization,
wherein the antenna apparatus is disposed on an inner surface of a tread, in which steel wires are embedded, of a tire.

2. The antenna apparatus according to claim 1 further comprising:
a metal base plate for holding the circuit board and the antenna element,
wherein the metal base plate is fixed on the inner surface of the tread, so that the circuit board and the antenna element are located at the inner side of the metal base plate in a radial direction of the tire.

3. The antenna apparatus according to claim 1, wherein the antenna apparatus is disposed on the inner surface at the center in a width direction of the tread.

4. The antenna apparatus according to claim 1, wherein the antenna element is an inverse-F antenna.

5. The antenna apparatus according to claim 1, wherein the antenna element is a compound antenna which includes a helical antenna and a monopole antenna, the helical antenna extending helically and having an end connected to the metal base plate and another end being open, the monopole antenna being vertically mounted at a location to be substantially aligned with the center line of the helical antenna and having an end connected to the high-frequency circuit and another end being open, the helical antenna and the monopole antenna being electromagnetically connected to each other.

6. The antenna apparatus according to claim 1 further comprising:
a case made of synthetic resin for covering the circuit board and the antenna element.
